(19) United States
(12) Patent Application Publication
(10) Pub. No.: US 2007/0089897 A1
(43) Pub. Date: Apr. 26, 2007

(54) Enclosure cover and method for making an enclosure cover

(75) Inventors: Donald N. Zimmer, Marshalltown, IA (US); John Nhu Tran, The Colony, TX (US)

Correspondence Address: LAW OFFICE OF DONALD D. MONDUL, 3060 Bonsai Drive, Plano, TX, 75093, US

(73) Assignee: Lennox Manufacturing, Inc.

(21) Appl. No.: 11/245,633

(22) Filed: Oct. 7, 2005

(51) Int. Cl. H02G 15/08

(52) U.S. Cl. 174/93

(57) ABSTRACT

A covering apparatus for an enclosure presenting a ventilating barrier curved with respect to a barrier axis includes a segmented panel member having a plurality of louvered areas. Respective adjacent louvered areas of the plurality of louvered areas are separated by a respective bend structure. Each respective bend structure has a first section departing in a first direction from a first bend axis and a second section departing in a second direction from a second bend axis. The first and second bend axes are generally parallel with the barrier axis. The first direction is generally away from the second bend axis. The second direction is generally away from the first bend axis. The bend structure further has a third section extending from the first and second bend axes to a third bend axis. The third bend axis is non-coplanar with the first and second bend axes.

### BACKGROUND OF THE INVENTION

The present invention is directed to equipment enclosure structures, and especially to equipment enclosure structures providing ventilation to enclosed equipment. By way of example and not by way of limitation, the present invention is particularly useful for enclosing HVAC (Heating, Ventilating and Air Conditioning) equipment.

It is sometimes desired to enclose equipment in a cabinet or similar enclosure having a curved panel, such as a curved exterior panel. By way of example and not by way of limitation, a cabinet may enclose HVAC equipment with a louvered or otherwise ventilating configuration in a curved installation orientation. There are problems with curving planar panels to conform with an installed curved orientation. Problems may include, for example, buckling or other uncontrollable deformation of the panel during bending. The problems may be exacerbated when the panel to be formed into a curved installation orientation includes louvers. Louvers may be distorted during bending in addition to causing deformation of the panel.

There is a need for a barrier for an enclosure and a method for making the enclosure that may be formed from a planar configuration to a curved installation orientation without significant deformation of the barrier.

There is a need for a barrier for an enclosure and a method for making the enclosure that may be formed from a planar configuration to a curved installation orientation including louvers in the barrier without significant deformation of the barrier or the louvers.

### SUMMARY OF THE INVENTION

A covering apparatus for an enclosure presenting a ventilating barrier curved with respect to a barrier axis includes a segmented panel member having a plurality of louvered areas. Respective adjacent louvered areas of the plurality of louvered areas are separated by a respective bend structure. Each respective bend structure has a first section departing in a first direction from a first bend axis and a second section departing in a second direction from a second bend axis. The first and second bend axes are generally parallel with the barrier axis. The first direction is generally away from the second bend axis. The second direction is generally away from the first bend axis. The bend structure further has a third section extending from the first and second bend axes to a third bend axis. The third bend axis is non-coplanar with the first and second bend axes.

A method for covering an enclosure with a ventilating barrier presenting a predetermined curve with respect to a barrier axis includes the steps of: (a) Providing a segmented panel member having a plurality of louvered areas. (b) Providing a respective bend structure separating respective adjacent louvered areas of the plurality of louvered areas. Each respective bend structure has a first section departing in a first direction from a first bend axis and a second section departing in a second direction from a second bend axis. The first and second bend axes are generally parallel with the barrier axis. The first direction is generally away from the second bend axis. The second direction is generally away from the first bend axis. The bend structure further has a third section extending from the first and second bend axes to a third bend axis. The third bend axis is non-coplanar with the first and second bend axes. (c) Manipulating the segmented panel member to conform substantially to the predetermined curve.

It is, therefore, an object of the present invention to provide an enclosure and a method for making the enclosure that may be formed from a planar configuration to a curved installation orientation without significant deformation of the barrier.

It is a further object of the present invention to provide an enclosure and a method for making the enclosure that may be formed from a planar configuration to a curved installation orientation including louvers in the barrier without significant deformation of the barrier or the louvers.

Further objects and features of the present invention will be apparent from the following specification and claims when considered in connection with the accompanying drawings, in which like elements are labeled using like reference numerals in the various figures, illustrating the preferred embodiments of the invention.

### BRIEF DESCRIPTION OF THE DRAWINGS

FIG. 1 is a front plan view of the enclosure of the present invention.

FIG. 2 is an end view of the enclosure illustrated in FIG. 1 in a substantially flat orientation.

FIG. 3 is an end view of the enclosure illustrated in FIG. 1 in a curved orientation.

FIG. 4 is a section view of a demarcation bend structure taken along section 4 - 4 in FIG. 1.

FIG. 5 is an enlarged detail view of a termination of a demarcation bend structure.

FIG. 6 is a flow chart illustrating the method of the present invention.

### DETAILED DESCRIPTION OF THE PREFERRED EMBODIMENT

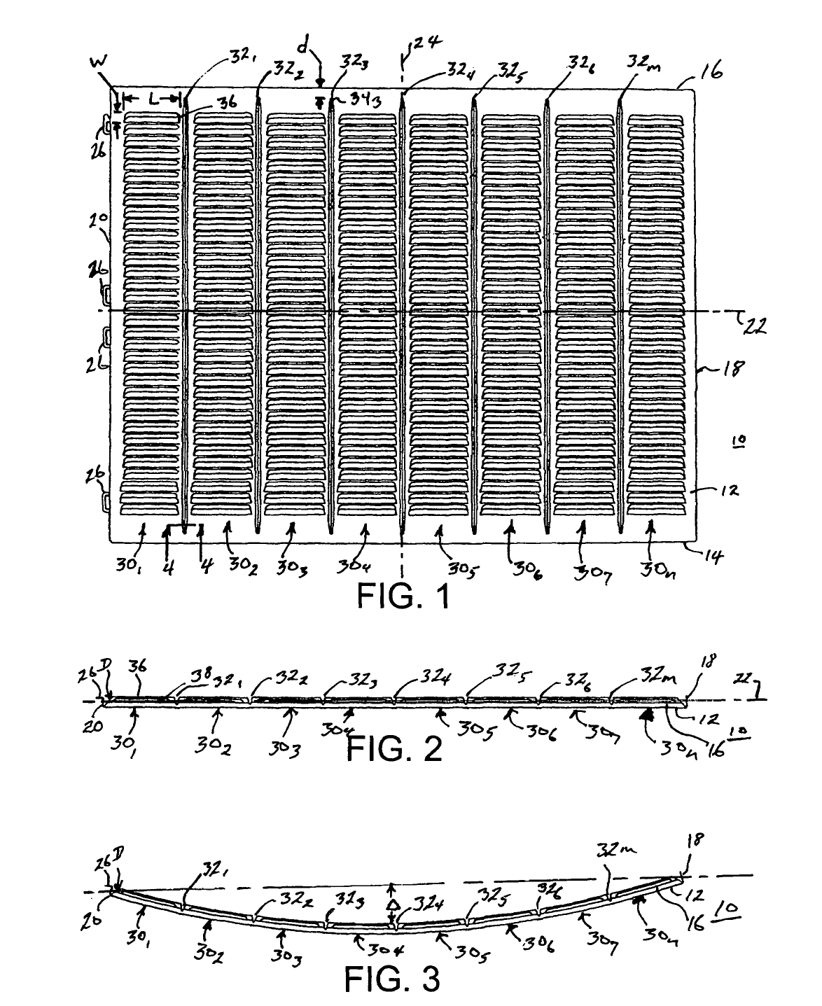

FIG. 1 is a front plan view of the enclosure of the present invention. FIG. 2 is an end view of the enclosure illustrated in FIG. 1 in a substantially flat orientation. FIG. 3 is an end view of the enclosure illustrated in FIG. 1 in a curved orientation. Regarding FIGS. 1-3, a cover apparatus 10 is configured of a substantially planar generally rectangular panel 12 having opposing sides 14, 16 and opposing sides 18, 20. Panel 12 is substantially symmetrical with respect to a first axis 22 and with a second axis 24. Axis 24 is substantially perpendicular with axis 22. Mounting structures, such as tabs 26, may be provided for mounting panel 12 to cover an enclosure (not shown in FIGS. 1-3).

Panel 12 is arranged having a plurality of areas 30₁, 30₂, 30₃, 30₄, 30₅, 30₆, 30₇, 30ₙ separated and defined by demarcation structures 32₁, 32₂, 32₃, 32₄, 32₅, 32₆, 32ₘ. The indicators “n” and “m” are employed to signify that there can be any number of areas separated by any number of demarcation structures in panel 12. The inclusion of eight areas 30₁, 30₂, 30₃, 30₄, 30₅, 30₆, 30₇, 30ₙ and seven demarcation structures 32₁, 32₂, 32₃, 32₄, 32₅, 32₆, 32ₘ in FIGS. 1-3 is illustrative only and does not constitute any limitation regarding the number of areas and demarcation structures that may be included in the apparatus of the present invention. In the preferred embodiment of the present invention, m=n−1.

Selected areas 30ₙ include a plurality of louver structures 36; in order to simplify the drawings, only a representative louver structure 36 in area 30₁ will be described in detail. Louver structures in other areas 30₂, 30₃, 30₄, 30₅, 30₆, 30₇, 30ₙ are preferably substantially similar with louver structures 36 located in area 301. Louver structure 36 is formed having a length L along an axis substantially parallel with axis 22 and a width W substantially parallel with axis 24. Louver structure 36 extends a depth D away from panel 12, thereby establishing an aperture 38 through panel 12. Preferably, all louver structures 36 extend depth D from panel 12 on the same side of panel 12. Aperture 38 provides a via through panel 12 permitting an exchange of air between equipment within an enclosure that includes panel 12 and an ambient space.

Panel 12 is configured as a segmented panel 12 having a plurality of louvered areas 30ₙ separated by respective demarcation or bend structures 32ₘ. Respective bend structures 32ₘ may each be configured to taper to a termination locus 34ₘ as representatively indicated at a termination locus 34₃ in FIG. 1. Termination locus 34₃ establishes an end point for bend structure 32₃ a distance d from side 16 to avoid wrinkling or buckling of panel 12 at side 16 when panel 12 is flexed or bent. Termination locus 34₃ is further described in connection with FIG. 5. In order to simplify this description of the present invention, only one representative termination locus 34₃ is described here and in connection with FIG. 5. Each respective bend structure 32ₘ preferably has substantially similar termination loci at each end, adjacent each of sides 14, 16.

When panel 12 is installed in an enclosure (not shown in FIGS. 1-3) panel 12 is manipulated to conform substantially to a predetermined installation curve established by the enclosure with which panel 12 is connected during installation. A representative such predetermined curve is presented in FIG. 3. In FIG. 3, panel 12 has flexed or bowed to establish a deflection distance Δ from axis 22. Of importance is the lack of buckling or other deformation of sides 14, 16 and within each of areas 30ₙ. This result is achieved because of the presence of demarcation or bend structures 32ₘ between adjacent areas 30ₙ. Respective bend structures 32ₘ effect any bending required of panel 12 to conform with the desired predetermined installation curve. The final installed orientation of panel 12 is a segmented approximation of the predetermined installation curve; the curve is approximated by the plurality of straight areas 30ₙ between bend structures 32ₘ. All bending is effected at respective bend structures 32ₘ, thereby relieving any forces that may otherwise have acted upon respective areas 30ₙ to deform respective sections 30ₙ.

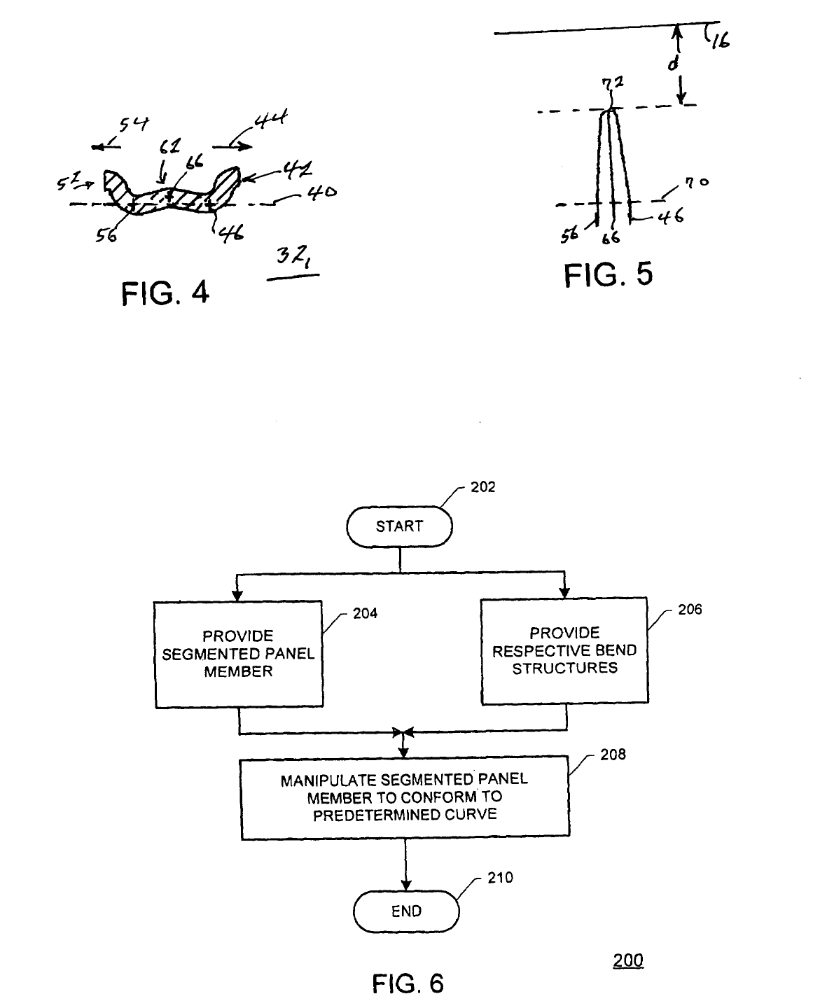

FIG. 4 is a section view of a demarcation bend structure taken along section 4-4 in FIG. 1. In FIG. 4, a representative demarcation or bend structure 32, is oriented generally on one side of a plane 40. Plane 40 is preferably parallel with axis 22 when panel 12 is in a substantially planar (i.e., unflexed) orientation (best seen in FIG. 1-2), and may be substantially contain axis 22 when panel 12 is in an unflexed orientation. Bend structure 32₁ is preferably substantially similar with each respective bend structure 32ₘ.

Bend structure 32₁ includes a first section 42 departing generally in a first direction 44 from a first axial bend locus 46 and a second section 52 departing generally in a second direction 54 from a second axial bend locus 56. First axial bend locus 46 and second axial bend locus 56 are generally parallel with one of axis 22 and axis 24 (FIGS. 1-3). First direction 44 is generally away from second axial bend locus 56. Second direction 54 is generally away from first axial bend locus 46. Bend structure 32₁ further includes a third section 62. Third section 62 extends from first axial bend locus 46 and from second axial bend locus 56 to a third axial bend locus 66. Third axial bend locus 66 is not coplanar with first axial bend locus 46 and second axial bend locus 56.

FIG. 5 is an enlarged detail view of a termination of a demarcation bend structure. In FIG. 5, a representative termination locus 34₃ terminates axial bend loci 46, 56, 66. Termination locus 34₃ is preferably substantially similar with termination loci at each end of each respective bend structure 32ₘ. Axial bend loci 46, 56, 66 are substantially parallel, as described in connection with FIG. 4, until a deviation locus 70 is reached. At deviation locus 70, axial bend loci 46, 56 begin to converge with axial bend locus 66. Convergence of axial bend loci 46, 56, 66 is substantially completed at an end locus 72. End locus 72 is a generally localized-area locus, approximating a point locus, situated distance d from side 16 of panel 12 (see FIG. 1) to avoid wrinkling or buckling panel 12 at side 16.

FIG. 6 is a flow chart illustrating the method of the present invention. In FIG. 6, a method 200 for covering an enclosure with a ventilating barrier presenting a predetermined curve with respect to a barrier axis begins at a START locus 202. Method 200 continues with, in no particular order: (1) Providing a segmented panel member having a plurality of louvered areas, as indicated by a block 204; and (2) providing a respective bend structure separating respective adjacent louvered areas of the plurality of louvered areas, as indicated by a block 204. Each respective bend structure has a first section departing in a first direction from a first bend axis and a second section departing in a second direction from a second bend axis. The first and second bend axes are generally parallel with the barrier axis. The first direction is generally away from the second bend axis. The second direction is generally away from the first bend axis. The bend structure further has a third section extending from the first and second bend axes to a third bend axis. The third bend axis is non-coplanar with the first and second bend axes. Method 200 continues by manipulating the segmented panel member to conform substantially to the predetermined curve, as indicated by a block 208. Method 200 terminates at an END locus 210.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

I claim:

1. An apparatus for covering an equipment enclosure; the apparatus comprising: a panel member having substantial symmetry about a first axis a second axis substantially perpendicular with said first axis; said panel member having a plurality of areas defined by at least one demarcation structure; said at least one demarcation structure having a first section located generally on a first side of said panel and departing in a first direction from a first axial bend locus and a second section located generally on said first side of said panel departing in a second direction from a second axial bend locus; said first and second axial bend loci being generally parallel with one of said first axis and said second axis; said first direction being generally away from said second axial bend locus; said second direction being generally away from said first axial bend locus; said demarcation structure further having a third section extending from said first and second axial bend loci to a third axial bend locus; said third axial bend locus being non-coplanar with said first and second axial bend loci.

2. An apparatus for covering an equipment enclosure as recited in claim 1 wherein at least one selected area of said plurality of areas includes a plurality of louver structures; said plurality of louver structures being arrayed along an axis generally parallel with said third axial bend locus of a respective said demarcation structure adjacent to said respective area.

3. An apparatus for covering an equipment enclosure as recited in claim 2 wherein each respective louver structure of said plurality of louver structures establishes an aperture having a length and a width; said length being oriented generally perpendicular with said third axial bend locus of said respective demarcation structure.

4. An apparatus for covering an equipment enclosure as recited in claim 1 wherein said plurality of areas is n areas and said at least one demarcation structure is n- I demarcation structures.

5. An apparatus for covering an equipment enclosure as recited in claim 4 wherein at least one selected area of said plurality of areas includes a plurality of louver structures; said plurality of louver structures being arrayed along an axis generally parallel with said third axial bend locus of a respective said demarcation structure adjacent to said respective area.

6. An apparatus for covering an equipment enclosure as recited in claim 5 wherein each respective louver structure of said plurality of louver structures establishes an aperture having a length and a width; said length being oriented generally perpendicular with said third axial bend locus of said respective demarcation structure.

7. A covering apparatus for an enclosure presenting a ventilating barrier curved with respect to a barrier axis; the apparatus comprising: a segmented panel member having a plurality of louvered areas; respective adjacent louvered areas of said plurality of louvered areas being separated by a respective bend structure; each said respective bend structure having a first section departing in a first direction from a first bend axis and a second section departing in a second direction from a second bend axis; said first and second bend axes being generally parallel with said barrier axis; said first direction being generally away from said second bend axis; said second direction being generally away from said first bend axis; said bend structure further having a third section extending from said first and second bend axes to a third bend axis; said third bend axis being non-coplanar with said first and second bend axes.

8. A covering apparatus for an enclosure presenting a ventilating barrier curved with respect to a barrier axis as recited in claim 7 wherein each respective said louvered area of said plurality of louvered areas includes a plurality of louver structures; each respective louver structure of said plurality of louver structures establishes an aperture having a length and a width; said length being oriented generally perpendicular with said barrier axis.

9. A covering apparatus for an enclosure presenting a ventilating barrier curved with respect to a barrier axis as recited in claim 7 wherein said plurality of louvered areas is n louvered areas.

10. A covering apparatus for an enclosure presenting a ventilating barrier curved with respect to a barrier axis as recited in claim 9 wherein the apparatus includes n- I said respective bend structures.

11. A covering apparatus for an enclosure presenting a ventilating barrier curved with respect to a barrier axis as recited in claim 8 wherein said plurality of louvered areas is n louvered areas.

12. A covering apparatus for an enclosure presenting a ventilating barrier curved with respect to a barrier axis as recited in claim 11 wherein the apparatus includes n−1 said respective bend structures.

13. A method for covering an enclosure with a ventilating barrier presenting a predetermined curve with respect to a barrier axis; the method comprising the steps of:
(a) In no particular order:
(1) providing a segmented panel member having a plurality of louvered areas; and
(2) providing a respective bend structure separating respective adjacent louvered areas of said plurality of louvered areas; each said respective bend structure having a first section departing in a first direction from a first bend axis and a second section departing in a second direction from a second bend axis; said first and second bend axes being generally parallel with said barrier axis; said first direction being generally away from said second bend axis; said second direction being generally away from said first bend axis; said bend structure further having a third section extending from said first and second bend axes to a third bend axis; said third bend axis being non-coplanar with said first and second bend axes; and
(b) manipulating said segmented panel member to conform substantially to said predetermined curve.

14. A method for covering an enclosure with a ventilating barrier presenting a predetermined curve with respect to a barrier axis as recited in claim 13 wherein each respective said louvered area of said plurality of louvered areas includes a plurality of louver structures; each respective louver structure of said plurality of louver structures establishes an aperture having a length and a width; said length being oriented generally perpendicular with said barrier axis.

15. A method for covering an enclosure with a ventilating barrier presenting a predetermined curve with respect to a barrier axis as recited in claim 13 wherein said plurality of louvered areas is n louvered areas.

16. A method for covering an enclosure with a ventilating barrier presenting a predetermined curve with respect to a barrier axis as recited in claim 15 wherein the apparatus includes n−1 said respective bend structures.

17. A method for covering an enclosure with a ventilating barrier presenting a predetermined curve with respect to a barrier axis as recited in claim 14 wherein said plurality of louvered areas is n louvered areas.

18. A method for covering an enclosure with a ventilating barrier presenting a predetermined curve with respect to a barrier axis as recited in claim 17 wherein the apparatus includes n−1 said respective bend structures.

19. A ventilating barrier for an enclosure; the barrier having a predetermined curved orientation about a barrier axis in an installed orientation; the barrier comprising: a segmented panel member having a plurality of louvered areas; respective adjacent louvered areas of said plurality of louvered areas being separated by a respective bend structure; each said respective bend structure having a plurality of sections connecting a plurality of bend axes; each respective bend axis of said plurality of bend axes being substantially parallel with said barrier axis; said plurality of sections cooperating to substantially establish said predetermined curved orientation in response to a bending force urging said panel member toward said installed orientation.
